(19) United States
(12) Patent Application Publication
(10) Pub. No.: US 2003/0135413 A1
(43) Pub. Date: Jul. 17, 2003

(54) Advertisement system and a control program therefor

(76) Inventors: Takashi Nishi, Osaka (JP); Akihiro Okumura, Hyogo (JP)

Correspondence Address: RABIN & BERDO, P.C., SUITE 500, 1101 14TH STREET, N.W., WASHINGTON, DC, 20005, US

(21) Appl. No.: 10/305,030

(22) Filed: Nov. 27, 2002

(30) Foreign Application Priority Data
Jan. 11, 2002 (JP) 2002-004074

(51) Int. Cl. G06F 17/60; G06F 1/00

(52) U.S. Cl. 705/14; 708/110

(57) ABSTRACT

When a customer terminal accesses a commercial site via an affiliate site, a total visit number calculator increments the number of visit to the commercial site. This data is stored in a visited commercial site ranking database. A contingent fee calculator determines how much contingent fee should be remitted to the commercial site from the affiliate site based on the number of visits stored in the ranking database. This advertisement system provides a rule of remitting a certain amount of profit to the commercial site if the commercial site serves as a priming site, which provides the customer with some type of motivation to visit another commercial site.

### BACKGROUND OF THE INVENTION

1. Field of the Invention

The present invention relates to an advertisement system useful for an on-line shopping system operated on a network, and more particularly to a method of determining a return (i.e., payment of a secondary contingent fee) to (a company running) a commercial site.

2. Description of the Related Art

An e-commerce company often places a banner advertisement on many Internet sites (web sites) in order to have more accesses to a commercial site of the e-commerce company from viewers (consumers or customers). When a viewer watching a certain Internet site clicks the banner advertisement, a viewer's terminal is automatically connected to the commercial site of the e-commerce company.

In some advertisement systems, a contingent fee is paid to an Internet site in which the banner advertisement is placed. This is called “affiliate marketing”. The affiliate marketing is a system (scheme) in which the e-commerce company pays an advertisement expense to the Internet site displaying the banner advertisement only when a viewer sees the banner advertisement and purchases a product of the e-commerce company. In general, the advertisement expense varies with how many products are purchased.

One of such advertisement systems is disclosed in Japanese Patent Application Kokai No. 2001-117847, published Apr. 27, 2001 and entitled “Network Advertisement Distribution Management And Point Return System”. In this system, a plurality of commercial sites are prepared by an e-commerce company on the Internet to offer different products for sale. The commercial sites are linked to advertisement displaying sites (i.e., affiliate sites) such that banner advertisements of the products or the e-commerce company appears on the affiliate sites. A master server system on the Internet distributes the banner advertisements to the affiliate sites and manages the banner advertisements.

When a viewer or customer clicks a banner advertisement on a certain affiliate site, a viewer's terminal is connected to the commercial site linked to the clicked banner advertisement. In other words, the viewer accesses the desired commercial site via the affiliate site. In order to admit (establish) the access to the desired commercial site, the advertisement system first connects to the master server system to deliver an identification number of the affiliate site, URL of the affiliate site and an IP address of the viewer to the master server system. Each affiliate site has its own identification number. The master server system then connects the commercial site page to the viewer's terminal. The commercial site supplies access information (e.g., information about who has accessed the commercial site and what the customer has purchased) to the master server system every time the customer accesses the commercial site and purchases a product. The master server system keeps the access information. When the customer visits the commercial site via the affiliate site, the master server system obtains affiliate site information from the commercial site. If the commercial site receives a purchase cancellation notice from the customer, the commercial site informs the master server system of such fact.

As the master server system receives the above mentioned information, the master server system prepares a contingent fee report for each of the commercial sites. The master server system then sends the reports to the affiliate sites together with contingent fees, respectively.

In the above described system, the contingent fee (primary contingent fee) is paid to the affiliate site if a consumer visits a commercial site via the affiliate site to buy something at the commercial site. However, there is no rule as to how much return (secondary contingent fee) should be paid back to the commercial site which urges the consumer to visit the affiliate site.

The consumer may visit the affiliate site to reach the commercial site (referred to as “first commercial site”) in order to receive some benefit such as a prize, a premium or a bonus from the first commercial site. As the consumer repeatedly visits the affiliate site for this purpose, the consumer may visit another commercial site (referred to as “second commercial site”) because a banner advertisement of the second commercial site is placed in the affiliated site. In such a case, the first commercial site servers as “priming” which urges the consumer to visit the second commercial site. In the conventional advertisement system, no contingent fee (i.e., secondary contingent fee) is paid to the priming site (i.e., the first commercial site).

### SUMMARY OF THE INVENTION

An object of the present invention is to provide a system which can remit an appropriate amount of secondary contingent fee.

According to a first aspect of the present invention, there is provided an advertisement system comprising: a plurality of commercial sites which offer merchandise for sale; an advertisement placing site which places a plurality of advertisements linked to the plurality of commercial sites respectively, the advertisement placing site receiving an advertisement fee based on the plurality of advertisements; and a return calculator for determining how much return should be remitted to each of the plurality of commercial sites from the advertisement placing site based on a number of customer accesses to each of the plurality of commercial sites via the advertisement placing site.

According to a second aspect of the present invention, there is provided an advertisement system comprising: a plurality of commercial sites which offer merchandise for sale; an advertisement placing site which places a plurality of advertisements linked to the plurality of commercial sites respectively, the advertisement placing site receiving an advertisement fee based on the plurality of advertisements; and a return calculator for determining how much return should be remitted to each of the plurality of commercial sites from the advertisement placing site based on an amount of merchandise purchased at each of the plurality of commercial sites by customers who access the plurality of commercial sites via the advertisement placing site.

According to a third aspect of the present invention, there is provided an advertisement system comprising: a plurality of commercial sites which offer merchandise for sale; an advertisement placing site which places a plurality of advertisements linked to the plurality of commercial sites respectively, the advertisement placing site receiving an advertisement fee based on the plurality of advertisements; a last time visit detector for detecting which commercial site a customer has visited via the advertisement placing site immediately before a most recent visit to a commercial site via the advertisement placing site, thereby calculating a number of last time visits to each of the plurality of commercial sites; and a return calculator for determining how much return should be remitted to each of the plurality of commercial sites from the advertisement placing site based on a number of customer accesses to each of the plurality of commercial sites via the advertisement placing site and the number of last time visits.

According to a fourth aspect of the present invention, there is provided an advertisement system comprising: a plurality of commercial sites offer merchandise for sale; an advertisement placing site which places a plurality of advertisements linked to the plurality of commercial sites respectively, the advertisement placing site receiving an advertisement fee based on the plurality of advertisements; a last time visit detector for detecting which commercial site a customer has visited via the advertisement placing site immediately before a most recent visit to a commercial site via the advertisement placing site, thereby calculating a number of last time visits to each of the plurality of commercial sites; and a return calculator for determining how much return should be remitted to each of the plurality of commercial sites from the advertisement placing site based on an amount of merchandise purchased at each of the plurality of commercial sites by customers who access the plurality of commercial sites via the advertisement placing site, and based on the number of last time visits.

According to a fifth aspect of the present invention, there is provided a computer program product configured for an advertisement system including a plurality of commercial sites which offer merchandise for sale, and an advertisement placing site which places a plurality of advertisements linked to the plurality of commercial sites respectively, the advertisement placing site receiving an advertisement fee based on the plurality of advertisements, the computer program product comprising a computer readable medium having computer program code stored therein, the computer program code configured so that a computer executes the step of determining how much return should be remitted to each of the plurality of commercial sites from the advertisement placing site based on a number of customer accesses to each of the plurality of commercial sites via the advertisement placing site.

### BRIEF DESCRIPTION OF THE DRAWINGS

FIG. 1 illustrates a block diagram of an advertisement system according to one embodiment of the present invention;

FIG. 2 illustrates a database of visited commercial site ranking used in the advertisement system shown in FIG. 1;

FIG. 3 illustrates a database of contingent fee report used in the advertisement system shown in FIG. 1;

FIG. 4 illustrates a block diagram of a main body of an advertisement system according to a second embodiment of the present invention; and

FIG. 5 illustrates a database of visited commercial site ranking used in the advertisement system shown in FIG. 4.

### DETAILED DESCRIPTION OF THE INVENTION

Embodiments of the present invention will be described with reference to the accompanying drawings.

First Embodiment:

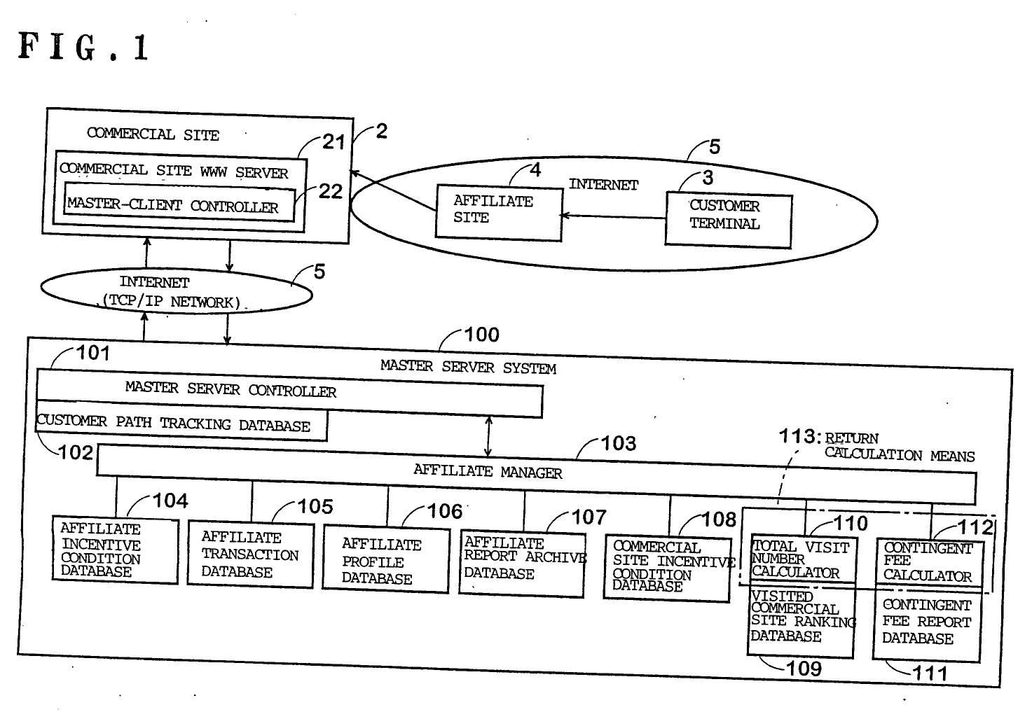

Referring to FIG. 1, an advertisement system according to a first embodiment of the present invention is illustrated. This system includes a master server system 100, a commercial site 2, a customer terminal 3, an affiliate site 4 and a network 5.

The master server system 100 distributes advertisements to the affiliate site 4 and manages (handles) the advertisements. The master server system 100 includes a master server controller 101, a customer path tracking database 102, an affiliate manager 103, an affiliate incentive condition database 104, an affiliate transaction database 105, an affiliate profile database 106, an affiliate report archive database 107, an commercial site incentive condition database 108, a visited commercial site ranking database 109, a total visit number calculator 110, a contingent fee report database 111 and a contingent fee calculator 112. Each of these elements of the master server system 100 will be described in detail below.

The commercial site 2 is a hypothetical store on the network 5. The commercial site 2 has a commercial site www server 21. The commercial site www server 21 is a computer to show and sell merchandise to a customer who accesses the www server 21 via the network 5. This type of www server for the hypothetical store is known in the art so that detailed description of the www server 21 is omitted here. The www server 21 has a master-client controller 22. When a customer accesses the commercial site 2 and buys merchandise, the master-client controller 22 informs the master server controller 101 in the master server system 100 of such fact. It should be noted that a plurality of commercial sites 2 exist in the advertisement system, but only one commercial site 2 is illustrated in FIG. 1 for the sake of simplicity.

The customer terminal 3 is a computer connected to the network 5. The customer terminal 3 allows a customer to access the affiliate site 4 and/or the commercial site 2.

The affiliate site 4 is a site to place a banner advertisement for each commercial site 2. The affiliate site 4 is a computer connected to the network 5.

The network 5 is the Internet which operates on, for example, TCP/IP (Transmission Control Protocol/Internet Protocol). It should be noted, however, that the network 5 may be any suitable network as long as the network 5 can connect the master server system 100, the commercial site 2, the customer terminal 3 and the affiliate site 4 with each other. It should also be noted that a plurality of customer terminals 3 and affiliate sites 4 exist in the advertisement system, but only one customer terminal 3 and affiliate site 4 are illustrated in FIG. 1 for the sake of simplicity.

The structure of the master server system 100 will be described in detail.

The master server controller 101 cooperates with the master-client controller 22 of the commercial site www server 21 to collect (receive) information about page-to-page movement history and purchase history of the customer terminal 3. Based on such information, the master server controller 101 cooperates with the affiliate manager 103 and other server systems (not shown) in the master server system 100 to control data in the databases 104 to 109 and 111. To control the data includes to add, delete, change, modify and process the data.

The customer path tracking database 102 stores information about a purchase route of the customer, including the page-to-page movement. The term “purchase” includes any activity equivalent to purchasing. The purchase route may be “reached a commercial site A via the affiliate site 4”. The customer path tracking database 102 also stores information about purchasing, which is used to calculate (determine) incentive to the customer and the affiliate site 4.

The customer path tracking database 102 stores various items such as a referrer URL (Uniform Resource Locator), an affiliate identification number, a customer identification number and an access time when the customer terminal 3 makes an access to the commercial site 2. These items are stored in connection with an IP address of the customer terminal 3. The affiliate identification number indicates the affiliate site 4, through which the customer accesses the commercial site 2. The customer identification number is given to the customer (or customer terminal 3) if the customer is a registered member of the affiliate site 4 (or the advertisement system).

The affiliate site manager 103 controls the affiliate site 4. To control the affiliate site 4 includes to perform a registration procedure for becoming a registered member of the affiliate site 4, to calculate a contingent fee (primary contingent fee), to prepare a contingent fee report and to transfer the contingent fee to a designated bank account.

The affiliate incentive condition database 104 stores conditions to determine how much primary contingent fee the commercial site 2 should pay to the affiliate site 4 under what conditions, when the customer visits the commercial site 2 via the affiliate site 4 and purchases something from the commercial site 2.

The affiliate transaction database 105 stores data about account settlement to calculate the primary contingent fee to be paid to the affiliate site 4.

The affiliate profile database 106 stores a profile of each affiliate site 4.

The affiliate report archive database 107 stores data used to prepare the contingent fee report, which is delivered to the commercial site 2 and the affiliate site 4 respectively. Specifically, the affiliate report archive database 107 stores a report number, a total amount of primary contingent fee to be paid to the affiliate site 4, a transaction date and time, a name of merchandise purchased, a price of the merchandise, a name of the commercial site 2 at which the customer has purchased the merchandise, and cancellation/non-cancellation of the sales, in connection with the identification number of the commercial site 2 or the identification number of the affiliate site 4. The term “transaction” means an activity which creates the primary contingent fee. Thus, the cancellation of the sales is equivalent to the cancellation of the transaction.

The incentive condition database 108 stores conditions to determine how much secondary contingent fee the affiliate site 4 should pay (remit) to the commercial site 2 under what conditions, when the commercial site 2 servers as the “priming” site to urge the customer (or the customer terminal 3) to visit the affiliate site 4.

The visited commercial site ranking database 109 stores data of how many times the customers have visited the commercial sites 2 via the affiliate site 4. The ranking (i.e., 1st place, 2nd place, 3rd place, . . . ) is given to the commercial sites in accordance with the number of visits to the commercial sites 2, respectively.

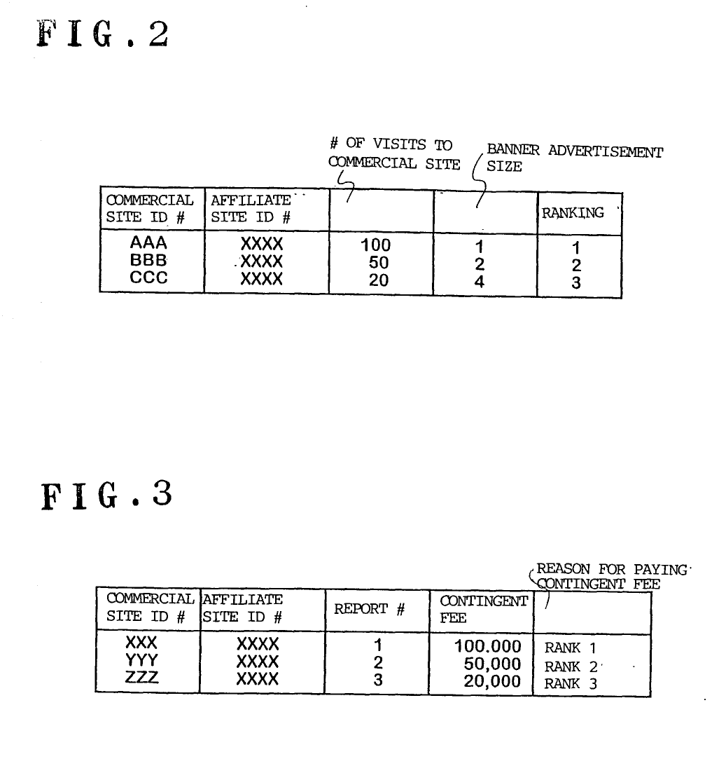

Referring to FIG. 2, an example of the visited commercial site ranking database 109 is illustrated. The ranking database 109 includes the affiliate identification number, the number of visits, a size of the banner advertisement and ranking, in connection with the identification number of each of the commercial sites 2.

The total visit number calculator 110 calculates how many times each of the commercial sites 2 has been visited via the affiliate site 4. Specifically, the calculator 110 updates the number of visits to the commercial site 2 every time the calculator 110 receives the commercial site identification number and the affiliate identification number from the affiliate manager 103. The most recent calculation result is stored in the ranking database 109.

The contingent fee report database 111 stores data about an amount of secondary contingent fee together with a reason of payment, in connection with the identification number of each commercial site 2. FIG. 3 illustrates an example of the contingent fee report database 111.

As shown in FIG. 3, the contingent fee report database 111 indicates the commercial site identification number, the affiliate site identification number, the report number, the secondary contingent fee and the reason (cause) for paying the secondary contingent fee.

The contingent fee calculator 112 calculates the secondary contingent fee on the basis of the data (i.e., the number of customer visits to the affiliate site 4, and the cause (motivation) to urge the customer to visit the affiliate site 4 for the purpose of visiting the commercial site 2) stored in the ranking database 109 for each of the commercial sites 2. The motivation to urge the customer to visit the affiliate site 4 for the purpose of visiting the commercial site 2 is how much priming effect the commercial site has. The contingent fee calculator 112 then prepares a report of secondary contingent fee to be remitted to the respective commercial sites 2.

The total visit number calculator 110 and the contingent fee calculator 112 constitute in combination a means 113 for calculating the secondary contingent fee for the respective commercial sites 2. The secondary contingent fee is a return money. When the customer terminal 3 repeatedly visits a certain commercial site 2 via the banner advertisement placed in the affiliate site 4, the affiliate site 4 considers that the commercial site 2 has made a contribution to the affiliate site 4. Thus, the affiliate site 4 pays back a particular amount of money to the commercial site 2 in accordance with the number of customer visits (customer accesses) to the commercial site 2. The total visit number calculator 110 is a combination of control programs and a hardware (e.g., processors and memories) to execute the control programs. Likewise, the contingent fee calculator 112 is a combination of control programs and a hardware (e.g., processors and memories) to execute the control programs.

Now, an operation of the advertisement system shown in FIG. 1 will be described.

Initial Setting:

The commercial site 2 accesses the affiliate manager 103 via the master server controller 101 from a browser (not shown) of the commercial site www server 21, for example. The commercial site 2 then informs the affiliate site 4, in which the banner advertisement of the commercial site 2 is placed, of the affiliate incentive condition. The affiliate incentive is the primary contingent fee to be paid to the affiliate site 4. The affiliate manager 103 stores the affiliate incentive condition in the affiliate incentive condition database 104.

The affiliate site 4 accesses the affiliate manager 103 via the master server controller 101 from a browser (not shown) to inform the affiliate manager 103 of its own affiliate profile information (e.g., affiliate site identification number and affiliate site URL). The affiliate manager 103 stores the affiliate profile information in the affiliate profile database 106.

The affiliate site 4 accesses the affiliate manager 103 via the master server controller 101 from the browser to inform the affiliate manger 103 of the commercial site incentive condition. The commercial site incentive is the secondary contingent fee or return (reward) to be remitted to the commercial site 2 from the affiliate site 4. The secondary contingent fee is remitted in return for the priming effect provided by the commercial site 2. The affiliate manager 103 stores the commercial site incentive condition in the commercial site incentive condition database 108.

These procedures are the initial setting for the commercial site 2 and the affiliate site 4. It should be noted, however, that the setting may be changed later. The setting for the commercial site 2 and the setting for the affiliate site 4 may be changed independently. Of course the advertisement system will operate in accordance with the changed setting.

When a Customer Accesses a Commercial Site:

The customer terminal 3 accesses a www server 21 of a desired commercial site 2 via the affiliate site 4.

Firstly, the master server controller 101 of the master server system 100 is called up. The master server controller 101 receives the identification number of the affiliate site 4, the URL of the affiliate site 4 and the IP address of the customer terminal 3. The URL of the affiliate site 4 is obtained by utilizing a referrer field function which HTTP inherently has. The master server controller 101 stores such information in the customer path tracking database 102.

The master server controller 101 transmits the affiliate site identification number to the affiliate manager 103. The affiliate manager 103 determines whether the affiliate site identification number matches an affiliated site identification number registered in the affiliate profile database 106. If these identification numbers match each other, the affiliate manager 103 automatically sends a page to the commercial site 2. The banner advertisement placed in the affiliate site 4 contains not only the URL of the commercial site 2 but also the URL of the master server system 100.

After that, the master-client controller 22 of the commercial site 2 sends the URL of the commercial site 2 and the IP address of the customer terminal 3 to the master server controller 101 every time the customer terminal 3 moves to another page in the commercial site 2. The URL of the commercial site 2 is sent by utilizing a referrer field function which HTTP inherently has. Besides such information, the merchandise information is also sent to the master server controller 101. Traveling path (movement history) and purchasing information of the customer terminal 3 is stored in the customer path tracking database 102 by the master server controller 101.

When a Customer Purchases Merchandise and Cancels the Purchase:

When the customer terminal 3 wants to purchase merchandise from the commercial site 2, the customer terminal 3 sends a notice of purchase to the commercial site 2. Upon receiving the notice of purchase, the commercial site 2 sends information about the purchase to the master server controller 101. The master server controller 101 then transfers the purchase information to the affiliate manager 103. The affiliate manager 103 receives and stores the purchase information in the affiliate transaction database 105.

When the customer terminal 3 wants to cancel the purchase, the customer terminal 3 sends a notice of cancellation to the commercial site 2. Upon receiving the notice of cancellation, the commercial site 2 sends information about the cancellation to the master server controller 101. The master server controller 101 then transfers the cancellation information to the affiliate manager 103. The affiliate manager 103 receives the cancellation information, and changes the data in the affiliate transaction database 105 in accordance with the cancellation information.

Preparation of Primary Contingent Fee Reports:

The master server controller 101 asks the affiliate manager 103 to prepare a contingent fee report (primary contingent fee report). The master server controller 101 requests the preparation of the contingent fee report once a month in this embodiment. It should be noted, however, that the master server controller 101 may be able to request the contingent fee preparation at an arbitrary timing.

As the affiliate manager 103 receives the report preparation request, the affiliate manager 103 makes a contingent fee report for each respective commercial site 2 on the basis of the data stored in the affiliate transaction database 105 and the affiliate incentive condition database 104. The contingent fee report is made for each of the affiliate sites 4. The contingent fee report indicates how much primary contingent fee should be paid to which affiliate site 4 from which commercial site 2. A primary contingent fee is paid to an affiliate site 4, in which a banner advertisement of a commercial site 2 is placed, when a customer terminal 3 visits the commercial site 2 via the affiliate site 4 predetermined times.

The contingent fee report is stored in the affiliate report archived at a base 107. Based on the contingent fee report, an invoice is sent to each commercial site 2. The master server system issues the invoice after the commercial site 2 affirms the contents of the contingent fee report.

The contingent fee report is also transmitted to each affiliate site 4. The primary contingent fee is then paid to a bank account of the affiliate site 4. Payment of the primary contingent fee is done by on-line processing or in any other suitable manner.

Access Ranking of the Commercial Sites:

When there is an access to the commercial site 2 from the customer terminal 3, the master-client controller 22 of the commercial site 2 sends information about the access to the master server system 100. Inside the master server system 100, the master server controller 101 receives the access information, and transmits the access information to the total visit number calculator 110 via the affiliate manager 103.

The total visit number calculator 110 increments the total number of visits of the commercial site 2 on the basis of the access information, and updates the ranking data. As shown in FIG. 2, the ranking data which includes the commercial site identification number and the number of visits for each commercial site is stored in the ranking database 109.

Preparation of Secondary Contingent Fee Reports:

The master server controller 101 asks the affiliate manager 103 to prepare a secondary contingent fee report. The secondary contingent fee report indicates how much secondary contingent fee (return) should be remitted to which commercial site from which affiliate site. The master server controller 101 requests the preparation of the secondary contingent fee report when the primary contingent fee report is prepared in this embodiment. It should be noted, however, that the master server controller 101 may be able to request the preparation of the secondary contingent fee report at an arbitrary timing.

Upon receiving the contingent fee report preparation request, the affiliate manager 103 asks the contingent fee calculator 112 to prepare the secondary contingent fee report. The contingent fee calculator 112 obtains the most recent data from the ranking database 109 and the commercial site incentive condition database 108, and calculates the secondary contingent fee on the basis of these data to prepare the secondary contingent fee report for each commercial site 2. A calculation method will be described later.

The secondary contingent fee report is stored in the contingent fee report database 111. After each affiliate site 4 affirms the contents of the secondary contingent fee report relating to the affiliate site 4, an invoice is issued to the affiliate site 4 in accordance with the secondary contingent fee report.

In the meantime, the secondary contingent fee report is sent to each commercial site 2 and the secondary contingent fee is transferred to a bank account of the commercial site 2. Payment of the secondary contingent fee may be done by on-line processing or in any other suitable manner.

Calculation of Secondary Contingent Fee:

The secondary contingent fee is calculated by the contingent fee calculator 112. To this end, the contingent fee calculator 112 firstly obtains the number of customer visits (customer accesses) to each commercial site 2, from the ranking database 109. For example, as shown in FIG. 2, it should be assumed that three commercial sites A, B and C (ID numbers AAA, BBB and CCC) place banner advertisements in the affiliate site 4 (ID number XXXXX) and customers have visited the commercial sites A, B and C 100 times, 50 times and 20 times via the affiliate site 4, respectively. It should also be assumed that a size of the banner advertisement of the commercial site B is twice as big as that of the commercial site A, and a size of the banner advertisement of the commercial site C is four times as big as that of the commercial site A. The commercial site A pays an advertisement fee of 1 yen for its banner advertisement, the commercial site B pays an advertisement fee of 2 yen for its banner advertisement, and the commercial site C pays an advertisement fee of 4 yen for its banner advertisement. The banner advertisement fee is a fee to be paid to the affiliate site 4 every time there is an access to the affiliate site 4.

A total number of visits of the customer terminals 3 to the affiliate site 4 for the purpose of reaching any of the commercial sites A, B and C is 170. Therefore, the total advertisement fee is given by the following equation:

170×1+170×2+170×4=1190 yen

The contingent fee calculator 112 then obtains the incentive information from the incentive condition database 108.

For example, the following incentive conditions are used (applied) to determine the secondary contingent fees:

1. The secondary contingent fee for the commercial site is determined in accordance with a ratio of the number of visits to the commercial site (100 for the commercial site A) to the total number of visits to the affiliate site 4 (170); and

2. 10% of the total advertisement fee goes to the affiliate site 4.

First, the condition 2 is applied to the total advertisement fee:

1190 yen×10%=119 yen. Therefore, the affiliate site 4 receives 119 yen.

Then, the condition 1 is applied to the rest of the total advertisement fee (1071 yen=1190 yen−119 yen).

The secondary contingent fee for each of the three commercial sites A, B and C is given by the following equations:

1071×100/170=630 yen Commercial site A:

1071×50/170=315 yen Commercial site B:

1071×20/170=126 yen Commercial site C:

As described above, the advertisement system establishes the rule of paying back a certain profit (return) to a commercial site 2 if the commercial site 2 provides a customer terminal 3 with some type of motivation to visit the affiliate site 4. In this advertisement system, the more attractive the commercial site 2 is, the more contingent fee the commercial site 2 receives. Therefore, commercial sites having power to attract tend to participate in the advertisement system. As a result, the affiliate site 4 can increase an amount of traffic passing through the affiliate site 4.

Second Embodiment:

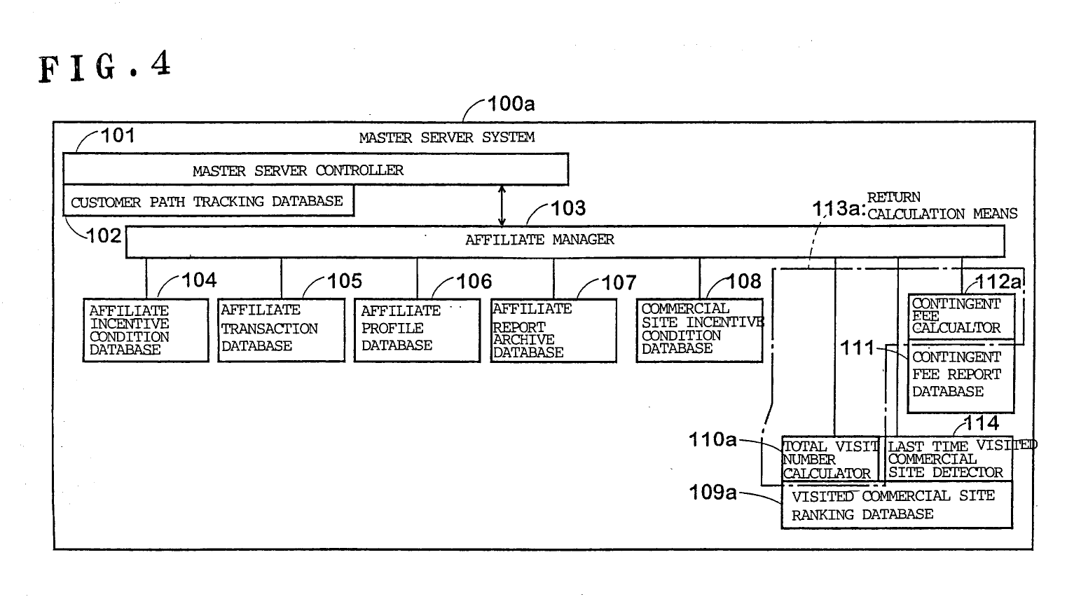

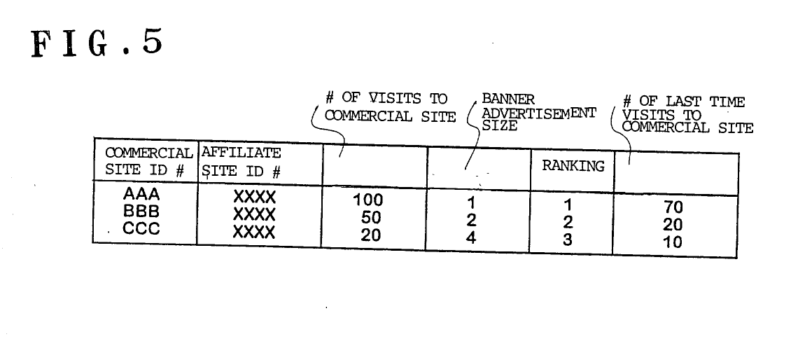

A second embodiment of the present invention will be described with reference to FIGS. 4 and 5.

In the second embodiment, a customer visiting history is additionally considered to determine the secondary contingent fee.

Referring to FIG. 4, the advertisement system of the second embodiment includes a commercial site 2, a customer terminal 3, an affiliate site 4, a network 5 and a master server system 100a. Because the commercial site 2, customer terminal 3, affiliate site 4 and network 5 in the second embodiment are the same as those in the first embodiment (FIG. 1), they are not illustrated in FIG. 4 nor described below. The master server system 100a in the second embodiment is different from the master server system 100 in the first embodiment.

The master server system 100a includes a master server controller 101, a customer path tracking database 102, an affiliate manager 103, an affiliate incentive condition database 104, an affiliate transaction database 105, an affiliate profile database 106, an affiliate report archive database 107, an commercial site incentive condition database 108, a visited commercial site ranking database 109a, a total visit number calculator 110a, a contingent fee report database 111, a contingent fee calculator 112a and a last visited commercial site detector 114.

The master server controller 101, customer path tracking database 102, affiliate manager 103, affiliate incentive condition database 104, affiliate transaction database 105, affiliate profile database 106, affiliate report archive database 107, commercial site incentive condition database 108, and contingent fee report database 111 in the second embodiment are the same as those in the first embodiment so that the same reference numerals are used and description of these elements is omitted.

The visited commercial site ranking database 109a stores data of how many times the customers have visited each commercial site 2 via the affiliate site 4. The ranking (i.e., 1st place, 2nd place, 3rd place, . . . ) is given to the commercial sites, respectively.

Referring to FIG. 5, an example of the visited commercial site ranking database 109a is illustrated. The ranking database 109a includes the affiliate site identification number, the number of customer visits, a size of the banner advertisement, ranking and the number of last-time-visits, in connection with the identification number of each of the commercial sites 2. The number of last-time-visits indicates how many times the commercial site 2 has been visited immediately before the most recent visit. If the customer terminal 3 visits the commercial sites A and B in succession, the number of last-time-visits for the commercial site A increments one because the commercial site A is the site visited last time immediately before the visit to the commercial site B.

The total visit number calculator 110a calculates how many times each of the commercial sites 2 has been visited via the affiliate site 4. Specifically, the calculator 110a updates the number of visits to the respective commercial sites 2 via the affiliate site 4 every time the calculator 110a receives the commercial site identification number and the affiliate identification number from the affiliate manager 103. The most recent calculation result is stored in the ranking database 109a. The total visit number calculator 110a also updates the number of last-time-visits in accordance with information supplied from the last time visited site detector 114.

The contingent fee calculator 112a calculates the secondary contingent fee on the basis of the data (i.e., the number of visits to the affiliate site 4, and the cause (motivation) to urge the customer to visit the affiliate site 4 for the purpose of reaching the commercial site 2) stored in the ranking database 109a for each of the commercial sites 2. The motivation to urge the customer to visit the affiliate site 4 for the purpose of reaching the commercial site 2 is how much priming effect the commercial site has. The contingent fee calculator 112a prepares a report of secondary contingent fee to be paid to the respective commercial sites 2, like the contingent fee calculator 112 in the first embodiment, but the contingent fee calculator 112a in the second embodiment considers the number of last-time-visits in determining the secondary contingent fee.

The total visit number calculator 110a and the contingent fee calculator 112a constitute in combination a means 113a for calculating the secondary contingent fee to be paid to each of the commercial sites 2. The secondary contingent fee is a return money. When the customer terminal 3 repeatedly visits a certain commercial site 2 via the banner advertisement placed in the affiliate site 4, the affiliate site 4 considers that the commercial site 2 has made a contribution to the affiliate site 4 (priming effect). Thus, the affiliate site 4 pays back a particular amount of money to the commercial site 2 in accordance with the number of visits to the commercial site 2. In this embodiment, the number of last-time-visits stored in the ranking database 109a is also taken into account as another contribution (priming effect). Therefore, the total number of customer visits and the total number of customer last visits are used to determine the secondary contingent fee.

The last time visited commercial site detector 114 investigates (checks) which commercial site the customer terminal 3 has visited immediately before the most recent visit, using the customer path tracking database 102. This investigation is performed every time the customer terminal 3 visits a certain commercial site. The last time visited commercial site detector 114 sends the investigation result to the total visit number calculator 110a.

Now, an operation of the advertisement system of the second embodiment will be described. It should be noted that the difference between the first and second embodiments lies in that the secondary contingent fee is calculated in consideration of the last time visit information. Therefore, the following description puts emphasis on this difference. “Initial setting”, “When a customer accesses a commercial site”, “When a customer purchases merchandise and cancels the purchase” and “Preparation of contingent fee reports for commercial sites” are generally the same as the first embodiment so that description of them is omitted.

Access Ranking of the Commercial Sites:

When there is an access to the commercial site 2 from the customer terminal 3, the master-client controller 22 of the commercial site 2 sends information about the access to the master server system 100a. Inside the master server system 100a, the master server controller 101 receives the access information, and transmits the access information to the affiliate site manager 103. The affiliate site manager 103 transmits the access information to the total visit number calculator 110a. The total visit number calculator 110a increments (updates) the total number of visits of the commercial site 2, stored in the ranking database 109a, on the basis of the access information, and updates the ranking data in the ranking database 109a.

At the same time, the affiliate site manager 103 transfers the access information to the last time visited commercial site detector 114. Upon receiving the access information, the last time visited commercial site detector 114 accesses the customer path tracking database 102 via the affiliate site manager 103 to search which commercial site the customer terminal 3 has visited immediately prior to the most recent visit. The last time visited commercial site detector 114 sends the search result to the total visit number calculator 110a. The total visit number calculator 110a then updates the total number of last time visits.

Preparation of Secondary Contingent Fee Reports:

The master server controller 101 asks the affiliate manager 103 to prepare a secondary contingent fee report. Upon receiving the contingent fee report preparation request, the affiliate manager 103 asks the contingent fee calculator 112a to make a calculation and prepare the secondary contingent fee report.

The contingent fee calculator 112a obtains the most recent data from the ranking database 109a and the commercial site incentive condition database 108, and calculates the secondary contingent fee on the basis of these data to prepare the secondary contingent fee report for each commercial site 2. The secondary contingent fee report is stored in the contingent fee report database 111. After each affiliate site 4 affirms the contents of the secondary contingent fee report relating to the affiliate site 4, an invoice is issued to the affiliate site 4 in accordance with the secondary contingent fee report. In the meantime, the secondary contingent fee report is sent to each commercial site 2 and the secondary contingent fee is transferred to a bank account of the commercial site 2. Payment of the secondary contingent fee may be done by on-line processing or in any other suitable manner.

Calculation of Secondary Contingent Fee:

The secondary contingent fee is calculated by the contingent fee calculator 112a. To this end, the contingent fee calculator 112a firstly obtains the number of visits to each commercial site 2 and the number of last time visits to each commercial site 2, from the ranking database 109a. For example, as shown in FIG. 5, it should be assumed that three commercial sites A, B and C, having ID numbers AAA, BBB and CCC respectively, place different sizes of banner advertisements in the single affiliate site 4 having ID number XXXX, and customers have visited the commercial sites A, B and C 100 times, 50 times and 20 times via the affiliate site 4, respectively. It should also be assumed that the number of last time visits to the commercial sites A, B and C are 70, 20 and 10, respectively.

The size of the banner advertisement of the commercial site B is twice as big as that of the commercial site A, and the size of the banner advertisement of the commercial site C is four times as big as that of the commercial site A. A banner advertisement fee is 1 yen for the banner advertisement of the commercial site A, 2 yen for the banner advertisement of the commercial site B, and 4 yen for the banner advertisement of the commercial site C. The banner advertisement fee is a fee to be paid to the affiliate site 4 every time there is an access to the affiliate site 4.

A total number of visits (accesses) of the customer terminals 3 to the affiliate site 4 for the purpose of reaching any of the commercial sites A, B and C is 170. Therefore, the total advertisement fee is given by the following equation:

170×1+170×2+170×4=1190 yen

The contingent fee calculator 112a then obtains the incentive information from the incentive condition database 108.

For example, the following incentive conditions are used to determine the secondary contingent fees:

1. The secondary contingent fee for the commercial site is determined in accordance with a ratio of the number of visits to the commercial site (100 for the commercial site A) to the total number of visits to the affiliate site 4 (170);

2. The number of last time visits to the commercial site is also considered in determining the secondary contingent fee in the same manner as the condition 1. Specifically, a ratio of the number of last time visits to the commercial site (70 for the commercial site A) to the total number of last time visits to the affiliate site 4 (100) is taken into account when determining the secondary contingent fee;

3. 70% of the secondary contingent fee is determined in accordance with the condition 1 and 30% of the contingent fee is determined in accordance with the condition 2; and

4. 10% of the total advertisement fee goes to the affiliate site 4.

First, the condition 4 is applied to the total advertisement fee:

1190 yen×10%=119 yen. Therefore, the affiliate site 4 receives 119 yen.

Then, the conditions 1 to 3 are applied to the rest of the total advertisement fee (1071 yen=1190 yen−119 yen).

The secondary contingent fee for each of the three commercial sites A, B and C is given by the following equations:

1071×70/100×100/170+1071×30/100×70/100=666 yen Site A:

1071×70/100×50/170+1071×30/100×20/100=285 yen Site B:

1071×70/100×20/170+1071×30/100×10/100=120 yen Site C:

The number of visits to the commercial site A increases as compared with the number of last time visits to the commercial site A. It can be said to the commercial sites B and C. One reason for such increase for all of the commercial sites A, B and C is because the commercial site A serves as a priming site. The commercial site A has attracted 70 last time visits. Accordingly, the commercial site A receives the largest secondary contingent fee among the three commercial sites A, B and C in the second embodiment.

As described above, the advertisement system establishes the rule of paying back a certain profit to a commercial site 2 if the commercial site 2 provides a customer terminal 3 with motivation to visit (access) the affiliate site 4. In this embodiment, the number of last time visits to the commercial site 2 is also considered to determine the secondary contingent fee, as compared with the first embodiment. Thus, more precise evaluation of the priming effect of the commercial site 2 is achieved.

The control programs for the total visit number calculator 110 (110a) and contingent fee calculator 112 (112a) are stored beforehand in the master server system 100 (100a) in the first and second embodiments, but the present invention is not limited in this regard. For instance, the control programs may be recorded on a portable computer-readable medium and installed into the master server system 100 (100a), or supplied to the master server system 100 (100a) from the network 5.

The secondary contingent fee is distributed from the total advertisement fee in the first and second embodiments. However, the present invention is not limited in this regard. For example, if the affiliate site 4 collects a member fee from each commercial site, part of the total member fee may be used as the secondary contingent fee.

The number of visits (accesses) to the commercial site and the advertisement fee are always used in the secondary contingent fee calculation in the first and second embodiments. However, the present invention is not limited in this regard. For example, the number of visits and the advertisement fee are used in the secondary contingent fee calculation only when the customer terminal purchases something at the commercial site 2. In other words, the total visit number calculator 110 (110a) counts (increments) the number of visits only when merchandise is purchased at the commercial site 2. Alternatively, the total visit number calculator 110 (110a) may be replaced by a total sales calculator, and the secondary contingent fee may be calculated on the basis of the total sales at the commercial site.

In the second embodiment, the last time visit is additionally considered in determining the secondary contingent fee. However, other factors (e.g., the number of visits before the last time visit, and the total sales (or sales history)) may also be considered. In addition, if the commercial site 2 has issued a coupon and/or gives an extra gift to the customer terminal, the secondary contingent fee to such commercial site may be calculated at a higher rate.

Although the return calculator 113 (113a) and last time visited commercial site detector 114 are provided in the master server system 100 (100a) in the first and second embodiments, the return calculator 113 (113a) and last time visited commercial site finder 114 may be provided in the commercial site 2, or may be provided outside the master server system 100 (100a), commercial site 2 and affiliate site 4.

What is claimed is:

1. An advertisement system comprising:
a plurality of commercial sites which offer merchandise for sale;
an advertisement placing site which places a plurality of advertisements linked to the plurality of commercial sites respectively, the advertisement placing site receiving an advertisement fee based on the plurality of advertisements; and
a return calculator for determining how much return should be remitted to each of the plurality of commercial sites from the advertisement placing site based on a number of customer accesses to each of the plurality of commercial sites via the advertisement placing site.

2. The advertisement system according to claim 1, wherein the return is remitted from the advertisement fee.

3. The advertisement system according to claim 1, wherein the advertisement is a banner advertisement.

4. The advertisement system according to claim 1 further including a report preparation unit for preparing a report of the return and a return pay unit for remitting the return to each of the plurality of commercial sites, wherein the return pay unit remits the return after each of the plurality of commercial sites affirms the report.

5. The advertisement system according to claim 1, wherein the advertisement placing site is an affiliate site.

6. An advertisement system comprising:
a plurality of commercial sites which offer merchandise for sale;
an advertisement placing site which places a plurality of advertisements linked to the plurality of commercial sites respectively, the advertisement placing site receiving an advertisement fee based on the plurality of advertisements; and
a return calculator for determining how much return should be remitted to each of the plurality of commercial sites from the advertisement placing site based on an amount of merchandise purchased at each of the plurality of commercial sites by customers who access the plurality of commercial sites via the advertisement placing site.

7. The advertisement system according to claim 6, wherein the return calculator includes a price factor of the merchandise purchased, when the return calculator determines the return.

8. The advertisement system according to claim 6, wherein the return is remitted from the advertisement fee.

9. The advertisement system according to claim 6, wherein the advertisement is a banner advertisement.

10. The advertisement system according to claim 6 further including a report preparation unit for preparing a report of the return and a return pay unit for remitting the return to each of the plurality of commercial sites, wherein the return pay unit remits the return after each of the plurality of commercial sites affirms the report.

11. The advertisement system according to claim 6, wherein the advertisement placing site is an affiliate site.

12. An advertisement system comprising:
a plurality of commercial sites which offer merchandise for sale;
an advertisement placing site which places a plurality of advertisements linked to the plurality of commercial sites respectively, the advertisement placing site receiving an advertisement fee based on the plurality of advertisements;
a last time visit detector for detecting which commercial site a customer has visited via the advertisement placing site immediately before a most recent visit to a commercial site via the advertisement placing site, thereby calculating a number of last time visits to each of the plurality of commercial sites; and
a return calculator for determining how much return should be remitted to each of the plurality of commercial sites from the advertisement placing site based on a number of customer accesses to each of the plurality of commercial sites via the advertisement placing site and the number of last time visits.

13. The advertisement system according to claim 12, wherein the return calculator gives less weight to the number of last time visits than the number of customer accesses to each of the plurality of commercial sites via the advertisement placing site when the return calculator determines the return.

14. The advertisement system according to claim 12, wherein the return is remitted from the advertisement fee.

15. The advertisement system according to claim 12, wherein the advertisement is a banner advertisement.

16. The advertisement system according to claim 12 further including a report preparation unit for preparing a report of the return and a return pay unit for remitting the return to each of the plurality of commercial sites, wherein the return pay unit remits the return after each of the plurality of commercial sites affirms the report.

17. The advertisement system according to claim 12, wherein the advertisement placing site is an affiliate site.

18. An advertisement system comprising:
a plurality of commercial sites offer merchandise for sale;
an advertisement placing site which places a plurality of advertisements linked to the plurality of commercial sites respectively, the advertisement placing site receiving an advertisement fee based on the plurality of advertisements;
a last time visit detector for detecting which commercial sites a customer has visited via the advertisement placing site before a most recent visit to a commercial site via the advertisement placing site, thereby calculating a number of last time visits to each of the plurality of commercial sites; and
a return calculator for determining how much return should be remitted to each of the plurality of commercial sites from the advertisement placing site based on an amount of merchandise purchased at each of the plurality of commercial sites by customers who access the plurality of commercial sites via the advertisement placing site, and based on the number of last time visits.

19. The advertisement system according to claim 18, wherein the return calculator includes a price factor of the merchandise purchased, when the return calculator determines the return.

20. The advertisement system according to claim 18, wherein the return calculator gives less weight to the number of last time visits than the amount of merchandise purchased at each of the plurality of commercial sites by customers who access the plurality of commercial sites via the advertisement placing site, when the return calculator determines the return.

21. The advertisement system according to claim 18, wherein the return is remitted from the advertisement fee.

22. The advertisement system according to claim 18, wherein the advertisement is a banner advertisement.

23. The advertisement system according to claim 18 further including a report preparation unit for preparing a report of the return and a return pay unit for remitting the return to each of the plurality of commercial sites, wherein the return pay unit remits the return after each of the plurality of commercial sites affirms the report.

24. The advertisement system according to claim 18, wherein the advertisement placing site is an affiliate site.

25. A computer program product configured for an advertisement system including a plurality of commercial sites which offer merchandise for sale, and an advertisement placing site which places a plurality of advertisements linked to the plurality of commercial sites respectively, the advertisement placing site receiving an advertisement fee based on the plurality of advertisements, the computer program product comprising a computer readable medium having computer program code stored therein, the computer program code configured so that a computer executes the step of:
A) determining how much return should be remitted to each of the plurality of commercial sites from the advertisement placing site based on a number of customer accesses to each of the plurality of commercial sites via the advertisement placing site.

26. The computer program product according to claim 25, wherein the return is remitted from the advertisement fee.

27. The computer program product according to claim 25, wherein the advertisement is a banner advertisement.

28. The computer program product according to claim 25, wherein the computer program code is further configured so that the computer executes the steps of:
B) preparing a report of the return after the step A; and
C) remitting the return to each of the plurality of commercial sites after each of the plurality of commercial sites affirms the report prepared in the step B.

29. The computer program product according to claim 25, wherein the advertisement placing site is an affiliate site.
